(19) United States
(12) Patent Application Publication
(10) Pub. No.: US 2013/0287466 A1
(43) Pub. Date: Oct. 31, 2013

(54) CROSS CUTTING DEVICE OF A REEL-FED PRINTING PRESS

(71) Applicant: MANROLAND WEB SYSTEMS GMBH, Augsburg (DE)

(72) Inventors: Peter KNAUER, Muenster/Lech (DE); Helmut Schnell, Augsburg (DE); Erich Stoeckle, Donauwoerth (DE)

(73) Assignee: Manroland Web Systems GmbH, Augsburg (DE)

(21) Appl. No.: 13/871,807

(22) Filed: Apr. 26, 2013

(30) Foreign Application Priority Data
Apr. 27, 2012 (DE) 10 2012 103 711.6

(51) Int. Cl. B41F 13/60

(52) U.S. Cl. CPC B41F 13/60
USPC 400/621; 83/346; 83/13; 83/34

(57) ABSTRACT

A cross cutting device of a reel-fed printing press for cutting copies off a printed substrate web through cross cutting of the substrate web is disclosed. The cross cutting device includes at least two cross cutting modules each of which include a cutting cylinder and a counterpart cylinder interacting with the cutting cylinder. Each of the cross cutting modules can be displaced between a working position and a rest position.

This application claims the priority of German Patent Document No. DE 10 2012 103 711.6, filed Apr. 27, 2012, the disclosure of which is expressly incorporated by reference herein.

### BACKGROUND AND SUMMARY OF THE INVENTION

The invention relates to a cross cutting device of a reel-fed printing press. The invention furthermore relates to a folding apparatus of a reel-fed printing press and a reel-fed printing press.

Reel-fed printing presses or folding apparatuses of reel-fed printing presses have a cross cutting device in order to cut individual copies off a printed substrate web by cross cutting the substrate web. For this purpose, cross cutting devices known from practice have a cylinder pair of a cutting cylinder and a counterpart cylinder interacting with the cutting cylinder, wherein the cutting cylinder carries at least one cutting knife, preferably a plurality of cutting knives.

In order to vary a so-called cut-off length of the copies cut off the substrate web through cross cutting, it is known from practice to vary either the number of the cutting knives positioned on the cutting cylinder or the rotational speed of the cutting cylinder. By doing so, a size variability with respect to the cut-off length of the copies cut off the printed substrate web can be ensured to a limited extent. However, the size variability that can be achieved is greatly restricted.

Starting out from this, the present invention is based on the object of creating a cross cutting device of a reel-fed printing press, which makes possible a greater size variability and thus product variability.

The cross cutting device according to the invention comprises at least two cross cutting modules, each of which comprise a cutting cylinder and a counterpart cylinder interacting with the cutting cylinder, wherein each of the cross cutting modules can be displaced between a working position and a rest position. Accordingly, the cross cutting device according to the invention comprises at least two cross cutting modules which can be alternately displaced between a working position and a rest position. Only one cross cutting module is in the working position at any time. By way of the different cross cutting modules, different cut-off lengths for copies cut off the substrate web can be ensured. Because of this, the size variability of a cross cutting device can be significantly increased relative to the prior art.

According to an advantageous further development of the invention, two or three cutting knives are exchangeably positioned on a cutting cylinder of a first cross cutting module, on the circumference of the cutting cylinder, wherein when the cutting cylinder of the first cross cutting module is occupied by two cutting knives on the circumference, the first cross cutting module serves for cutting off two copies for each cutting cylinder revolution, and wherein when the cutting cylinder of the first cross cutting module is occupied by three cutting knives on the circumference, the first cross cutting module serves for cutting off three copies for each cutting cylinder revolution. Preferably, the rotational speed of the cutting cylinder of the first cross cutting module is twice as high as a rotational speed of printing cylinders of the reel-fed printing press, so that when the cutting cylinder of the first cross cutting module is occupied by two cutting knives on the circumference, the first cross cutting module serves for cutting off four copies for each printing cylinder revolution, and that when the cutting cylinder of the first cross cutting module is occupied by three cutting knives on the circumference, the first cross cutting module serves for cutting off six copies for each printing cylinder revolution.

According to this advantageous further development of the invention, the first cross cutting module serves for cutting off four copies or six copies for each printing cylinder revolution.

According to an advantageous further development of the invention, two or three cutting knives are exchangeably positioned on a cutting cylinder of a second cross cutting module on the circumference of the cutting cylinder, wherein when the cutting cylinder of the second cross cutting module is occupied by two cutting knives on the circumference, the second cross cutting module serves for cutting off two copies for each cutting cylinder revolution, and wherein when the cutting cylinder of the second cross cutting module is occupied by three cutting knives on the circumference, the second cross cutting module serves for cutting off three copies for each cutting cylinder revolution. When the cutting cylinder of the second cross cutting module is occupied by two cutting knives on the circumference, the rotational speed of the cutting cylinder and the rotational speed of printing cylinders of the reel-fed printing press are at a ratio of 5:2, so that the second cross cutting module serves for cutting off five copies for each printing cylinder revolution. When the cutting cylinder of the second cross cutting module is occupied by three cutting knives on the circumference, the rotational speed of the cutting cylinder and the rotational speed of printing cylinders of the reel-fed printing press are at a ratio of 5:3, so that the second cross cutting module in turn serves for cutting off five copies for each printing cylinder revolution.

According to this advantageous further development of the invention, the second cross cutting module serves for cutting off five copies for each printing cylinder revolution.

Preferred further developments of the invention are obtained from the following description. Exemplary embodiments of the invention are explained in more detail by the drawings without being restricted thereto.

### BRIEF DESCRIPTION OF THE DRAWINGS

FIG. 1 is a detail of a folding apparatus or a reel-fed printing press in the region of a cross cutting device according to the invention in a first state; and

FIG. 2 is the detail from the folding apparatus or the reel-fed printing press in the region of the cross cutting device according to the invention in a second state.

### DETAILED DESCRIPTION OF THE DRAWINGS

The present invention relates to a cross cutting device of a reel-fed printing press, a folding apparatus of a reel-fed printing press having such a cross cutting device and a reel-fed printing press having such a cross cutting device.

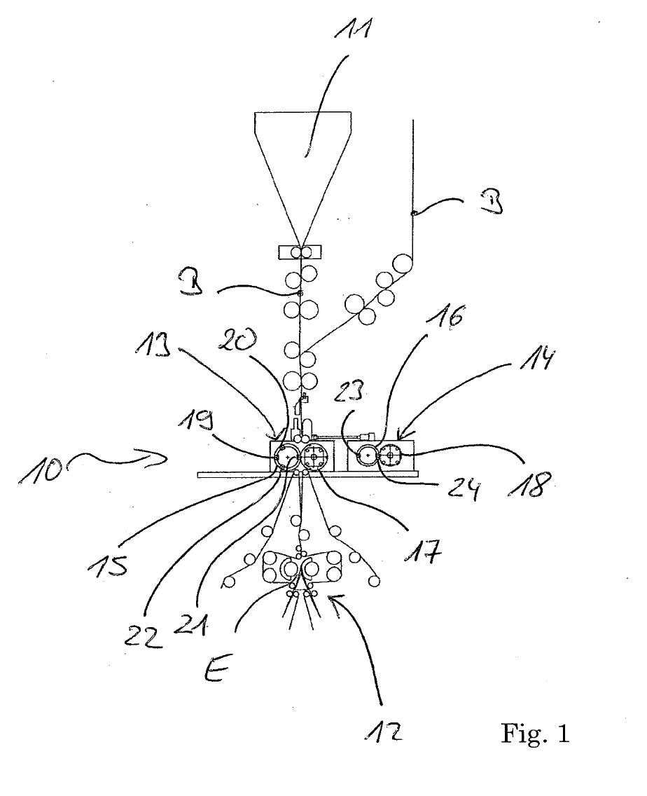

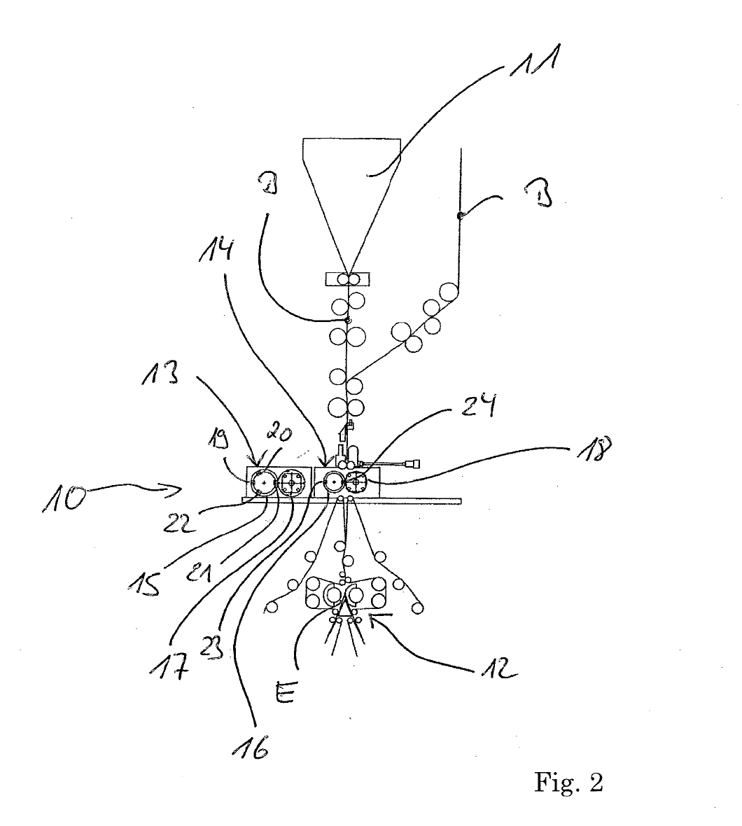

FIGS. 1 and 2 show details of a folding apparatus of a reed-fed printing press in the region of a cross cutting device 10 according to the invention. In the variant shown in FIGS. 1 and 2, a former 11 is arranged upstream of the cross cutting device 10 seen in the transport direction of a printed substrate web B, which serves for the longitudinal folding of the as yet not cross-cut substrate web B. Furthermore, a splitting device 12 is arranged downstream of the cross cutting device 10 in FIGS. 1 and 2 in order to assign copies E cut off the substrate web B to different product streams, wherein a folding apparatus can be arranged downstream or upstream of the splitting device 12 in order to form longitudinal folds and/or transverse folds on the copies E cut off the substrate web B.

As is evident from FIGS. 1 and 2, the substrate web B can also be guided past the former 11.

The cross cutting device 10 according to the invention comprises a plurality of cross cutting modules, namely according to FIGS. 1 and 2 a first cross cutting module 13 and a second cross cutting module 14. Each of the cross cutting modules 13 and 14 comprises a respective cutting cylinder 15 and 16 and a respective counterpart cylinder 17 and 18 interacting with the respective cutting cylinders 15 and 16.

The cross cutting modules 13 and 14 can be alternately displaced relative to the substrate web between a working position and a rest position, wherein in FIG. 1 the first cross cutting device 13 assumes the working position and the second cross cutting device 14 the rest position, and wherein in FIG. 2 the first cross cutting device 13 assumes the rest position and the second cross cutting device 14 the working position. In FIGS. 1 and 2 the two cross cutting modules 13 and 14 can be transferred between the respective working position and the respective rest position through translatory or linear displacing. In contrast with this it is also possible to transfer cross cutting modules between the respective working position and the respective rest position through pivoting or through a combination of linear displacement and pivoting.

The cylinder 15 of the first cross cutting module 13 in the exemplary embodiment of FIGS. 1 and 2 comprises four mountings 19, 20, 21 and 22 for cutting knives on its circumference, wherein two of these four mountings, namely the mountings 19 and 21 are offset relative to one another by 180° on the circumference of the cutting cylinder 15, and wherein three of these four mountings, namely the mountings 20, 21 and 22, are each offset relative to one another by 120° on the circumference of the cutting cylinder 15.

In this way, i.e., utilizing the mountings 19, 20, 21 and 22, either two cutting knives which are offset by 180° relative to one another can be positioned on the cutting cylinder 15 of the first cross cutting module 13 or three cutting knives, each of which are offset by 120° relative to one another, can be positioned on the cutting cylinder 15 of the first cross cutting module 13, wherein when the cutting cylinder 15 of the first cross cutting module 13 carries two cutting knives on the circumference, the first cross cutting module 13 serves for cutting off two copies for each revolution of the cutting cylinder 15, and wherein when the cutting cylinder 15 of the first cross cutting module 13 carries three cutting knives on the circumference, the first cross cutting module 13 serves for cutting off three copies for each revolution of the cutting cylinder 15.

The rotational speed of the cutting cylinder 15 of the first cross cutting module 13 is twice as high as a rotational speed of printing cylinders of the reel-fed printing press, so that when the cutting cylinder 15 of the first cross cutting module 13 carries two cutting knives on its circumference, the first cross cutting module 13 serves for cutting off four copies for each printing cylinder revolution, whereas when the cutting cylinder 15 of the first cross cutting module 13 is occupied by three cutting knives on the circumference, the cutting cylinder 15 then serves for cutting off six copies for each printing cylinder revolution.

The cutting cylinder 16 of the second cross cutting module 14 comprises two mountings 23 and 24 for cutting knives on its circumference, so that in the exemplary embodiment of FIGS. 1 and 2 for the cutting cylinder 16 of the second cross cutting module 14, the second cross cutting module 14 then serves for cutting off two copies for each cutting cylinder revolution of the cutting cylinder 16 of the second cross cutting module 14. In this case, the rotational speed of the cutting cylinder 16 of the cross cutting module 14 and the rotational speed of printing cylinders of the reel-fed printing press are at a ratio of 5:2, so that the second cross cutting module 14 then serves for cutting off five copies for each printing cylinder revolution.

Although not shown, it is also possible that the cutting cylinder 16 of the second cross cutting module 14 comprises three mountings distributed over its circumference for the exchangeable positioning of three cutting knives, wherein the cutting cylinder 16 of the second cross cutting module 14 then carries three cutting knives on the circumference and then serves for cutting off three copies for each revolution of the cutting knife cylinder 15. In this case, the rotational speed of the cutting cylinder 16 of the second cross cutting module 14 and the rotational speed of printing cylinders of the reel-fed printing press are then at a ratio of 5:3, so that the second cross cutting module 14 in turn serves for cutting off five copies for each printing cylinder revolution.

It is pointed out here that the diameter of the cutting cylinders 15 and 16, as well as of the counterpart cylinders 17 and 18, of the two cross cutting modules 13 and 14 are configured such that at the defined rotational speed of the respective cutting cylinders 15 and 16, a respective circumferential speed of the cutting cylinders approximately corresponds to the transport speed of the substrate web B. From this it follows that the cutting cylinders 15 and 16 of the two cross cutting modules 13 and 14 have different diameters.

Accordingly, depending on which of the cross cutting modules 13 and 14 assumes the working position, four or five or six copies can be cut off the substrate web B for each printing cylinder revolution with the embodiment of the cross-cutting device 10 according to the invention shown in FIGS. 1 and 2, wherein the first cross cutting module 13 serves for cutting off four or six copies and the second cross cutting module 14 for cutting off five copies.

Whether four or six copies are cut off with the first cross cutting module 13 depends on whether two cutting knives or three cutting knives are positioned on its circumference.

Accordingly, with the cross cutting device 10 of the present invention, variably different cut-off lengths for copies E to be cut off the substrate web B can be realized.

The invention furthermore relates to a folding apparatus having such a cross cutting device 10, wherein a former for longitudinal folding of the uncut substrate web B is arranged upstream of the cross cutting device 10 and/or a folding apparatus for longitudinal folding and/or transverse folding of the cut off copies E is arranged downstream of the cross cutting device 10.

The invention, furthermore, relates to a reel-fed printing press which in addition to at least one roll changer and a plurality of printing couples for printing the substrate web B, comprises at least one such cross cutting device 10 in order to cut copies E with a variable cut-off length off the printed substrate web B through cross cutting.

List of Reference Numbers:

10 Cross cutting device

11 Former

12 Splitting device

13 First cross cutting module

14 Second cross cutting module

15 Cutting cylinder

16 Cutting cylinder

17 Counterpart cylinder

18 Counterpart cylinder

19 Mounting

20 Mounting

21 Mounting

22 Mounting

23 Mounting

24 Mounting

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A cross cutting device of a reel-fed printing press, comprising:
a first cross cutting module; and
a second cross cutting module;
wherein each of the first and the second cross cutting modules include a cutting cylinder and a counterpart cylinder;
and wherein each of the first and the second cross cutting modules are displaceable between a respective working position and a respective rest position.

2. The cross cutting device according to claim 1, wherein the first and the second cross cutting modules are linearly displaceable between the respective working position and the respective rest position.

3. The cross cutting device according to claim 1, wherein the first and the second cross cutting modules are pivotable between the respective working position and the respective rest position.

4. The cross cutting device according to claim 1:
wherein the cutting cylinder of the first cross cutting module has two or three cutting knives positioned on a circumference of the cutting cylinder;
wherein when the cutting cylinder of the first cross cutting module has two cutting knives on the circumference, two copies are cutable off of a printed substrate web by the first cross cutting module for each cutting cylinder revolution;
and wherein when the cutting cylinder of the first cross cutting module has three cutting knives on the circumference, three copies are cutable off of the printed substrate web by the first cross cutting module for each cutting cylinder revolution.

5. The cross cutting device according to claim 4:
wherein a rotational speed of the cutting cylinder of the first cross cutting module is twice as high as a rotational speed of a printing cylinder of the reel-fed printing press such that:
when the cutting cylinder of the first cross cutting module has two cutting knives on the circumference, four copies are cutable off of the printed substrate web by the first cross cutting module for each cutting cylinder revolution;
and when the cutting cylinder of the first cross cutting module has three cutting knives on the circumference, six copies are cutable off of the printed substrate web by the first cross cutting module for each cutting cylinder revolution.

6. The cross cutting device according to claim 1, wherein the cutting cylinder of the first cross cutting module has four mountings for cutting knives on a circumference of the cutting cylinder, and wherein three of the four mountings are offset by 120° relative to each other and two of the four mountings are offset by 180° relative to each other on the circumference of the cutting cylinder.

7. The cross cutting device according to claim 1:
wherein the cutting cylinder of the second cross cutting module has two or three cutting knives positioned on a circumference of the cutting cylinder;
wherein when the cutting cylinder of the second cross cutting module has two cutting knives on the circumference, two copies are cutable off of a printed substrate web by the second cross cutting module for each cutting cylinder revolution;
and wherein when the cutting cylinder of the second cross cutting module has three cutting knives on the circumference, three copies are cutable off of the printed substrate web by the second cross cutting module for each cutting cylinder revolution.

8. The cross cutting device according to claim 7, wherein when the cutting cylinder of the second cross cutting module has two cutting knives on the circumference, a rotational speed of the cutting cylinder and a rotational speed of a printing cylinder of the reel-fed printing press are at a ratio of 5:2 such that five copies are cutable off of the printed substrate web for each printing cylinder revolution.

9. The cross cutting device according to claim 7, wherein when the cutting cylinder of the second cross cutting module has three cutting knives on the circumference, a rotational speed of the cutting cylinder and a rotational speed of a printing cylinder of the reel-fed printing press are at a ratio of 5:3 such that such that five copies are cutable off of the printed substrate web for each printing cylinder revolution.

10. The cross cutting device according to claim 1, wherein the cutting cylinder of the second cross cutting module has three mountings for cutting knives on a circumference of the cutting cylinder, wherein the three mountings are offset by 120° relative to each other, or the cutting cylinder of the second cross cutting module has two mountings for cutting knives on the circumference of the cutting cylinder, wherein the two mountings are offset by 180° relative to each other.

11. A folding apparatus of a reel-fed printing press, comprising:
cutting device according to claim 1;
a former for longitudinal folding of a substrate web disposed upstream of the cross cutting device and/or a folding apparatus for longitudinal folding and/or transverse folding of copies disposed downstream of the cross cutting device.

12. A reel-fed printing press, comprising:
a roll changer for providing a substrate web to be printed;
a printing couple for printing the substrate web; and
a cross cutting device according to claim 1.

13. A method of cutting copies off of a printed substrate web, comprising the steps of:
moving a first cross cutting module into a working position;
moving a second cross cutting module into a respective rest position; and
cutting a first quantity of copies off of the printed substrate web by the first cross cutting module.

14. The method according to claim 13, further comprising the steps of:
moving the first cross cutting module into a respective rest position;
moving the second cross cutting module into the working position; and
cutting a second quantity of copies off of the printed substrate web by the second cross cutting module, wherein the first quantity is different from the second quantity.
